(19) United States
(12) Patent Application Publication
(10) Pub. No.: US 2005/0094646 A1
(43) Pub. Date: May 5, 2005

(54) IP video terminal with function for controlling video transmission/reception bandwidth and image quality and control method thereof

(75) Inventor: Min-Jeong Lee, Seoul (KR)

Correspondence Address: HARNESS, DICKEY & PIERCE, P.L.C., P.O. BOX 828, BLOOMFIELD HILLS, MI, 48303, US

(73) Assignee: C and S technology Co., Ltd., Seoul (KR)

(21) Appl. No.: 10/976,282

(22) Filed: Oct. 28, 2004

(30) Foreign Application Priority Data
Oct. 30, 2003 (KR) 10-2003-76290

(51) Int. Cl. H04L 12/28

(52) U.S. Cl. 370/395.52; 370/352

(57) ABSTRACT

Disclosed are an IP (Internet Protocol) video terminal with a function for controlling video transmission/reception bandwidth and image quality and a control method thereof. While a call is in progress, the IP video terminal exchanges information with an opposite party and controls a transmission rate and quality of video from the opposite party. Moreover, while the call is in progress, the IP video terminal recognizes a network state and automatically controls video transmission quality according to a change of the network state. The IP video terminal can acquire more natural video by lowering a bandwidth value or/and an image quality value when quality of video from the opposite party is bad during the call.

### BACKGROUND OF THE INVENTION

1. Field of the Invention

The present invention relates to an IP (Internet Protocol) video terminal with a function for controlling video transmission/reception bandwidth and image quality and a control method thereof, and more particularly to an IP video terminal with a function for controlling video transmission/reception bandwidth and image quality and a control method in the same that can allow a user to control the video transmission/reception bandwidth and image quality so that the user can be adaptive to a dynamic change of Internet conditions during a call.

2. Description of the Related Art

The protocol providing service for transmitting and receiving voice data between two terminals over the Internet as in the conventional telephony service is referred to as VoIP (Voice over Internet Protocol). Because the VoIP service employs the Internet as a backbone network, it enables various types of digital information such as voice, video, text, etc. to be shared in one call, thus exceeding the limitations of transmitting and receiving only analog voice information in a PSTN (Public Switched Telephone Network). In particular, service with a video data exchange function in addition to the VoIP service is referred to as MoIP (Multimedia over IP).

The Internet transmits and receives data in units of packets. In this case, communication bandwidth between two terminals performing communication is not always ensured. Once a communication path is established, a data transmission/reception operation is performed while dynamically occupying bandwidth in a packet unit. Because of inherent characteristics of the Internet, a predetermined level of communication quality cannot be ensured. Moreover, packet loss or delay may be incurred according to Internet conditions during a call, such that communication quality can be degraded. However, as the Internet is widely used, performance or capacity of a network system is being improved and an environment capable of accessing the Internet is being improved.

Despite the fact that the number of Internet users increases and increased network bandwidth capacity is required due to the increased number of real-time media communication applications, it is difficult to ensure sufficient bandwidth for the real-time communication applications (e.g., various Internet games, Internet chatting, VoIP, MoIP, etc.).

As backbone network technologies supporting the Internet are rapidly developed and the Internet is supplied around the world, various multimedia data as well as character or text data can be transmitted and received between remote parties at relatively low cost. In order to maximally utilize this merit, MoIP provides voice and video communication service between users over the Internet. Moreover, MoIP is service for providing basis protocol and an infrastructure to enable voice and video data to be transmitted and received over an IP network. To generalize the MoIP service, international organizations have proposed standard protocols such as H.323 of ITU-T (International Telecommunication Union-Telecommunication), SIP (Session Initiation Protocol) of IETF (Internet Engineering Task Force), etc.

For the MoIP service, various control functions other than a call setup function between two terminals are required to smoothly transmit and receive voice and video data or to change setup values, during a call. For example, in case of the voice data, various control functions for the type of voice codec and codec-related parameter values are present. In case of the video data, there are present the various control functions for a type of video codec, codec-related parameter values, a video quality value during a call, communication bandwidth, screen stop, video recording, etc.

On the other hand, the Internet cannot continuously occupy necessary bandwidth due to its characteristics while the call is in progress as described above. Available bandwidth may rapidly vary during the call or according to a call time. Video communication bandwidth that is 5 to 10 times higher than voice communication bandwidth is required so that a relatively large amount of video data can be transmitted and received in high quality as compared with an amount of voice data. If this requirement is not satisfied, video communication quality can be seriously degraded. That is, when the video data is transmitted over the Internet at more than the bandwidth available in the IP video terminal, data may be partially lost or may arrive late at an opposite party, such that the quality of media that must perform real-time playback may be degraded.

A bandwidth control function is very important in the video communication. Typically, the IP video terminal designates, in advance, the bandwidth to be used for the video communication before the call is in progress, such that video can be transmitted and received at the designated bandwidth. However, this manner cannot cope with the bandwidth dynamically varying during the call.

A video compression codec used for the IP video communication is mainly based on H.261 or H.263. A parameter for controlling image quality in H.261 or H.263 is a QP (Quantization Parameter). The QP has a value between 1 and 31. The higher the QP value the more roughly are images compressed, such that image quality is low. In contrast, the lower the QP value the more finely are images compressed, such that image quality is high.

In the video compression, an image quality factor significantly affects a compression rate. As image quality is bad, a compression rate becomes high and hence small communication bandwidth is required. In contrast, as image quality is good, a compression rate becomes small and hence large communication bandwidth is required. In terms of the same bandwidth, motion of an object is naturally viewed because the time required for compressing one image is short as image quality is low, while motion of an object is slowly viewed because the time required for compressing one image is long as image quality is high.

As described above, the bandwidth, video object motion, and image quality have an intimate relationship therebetween. The image quality can differ according to selection of a user taking into account a merit and drawback between natural motion and a clear image. The typical IP video terminal allows a user to select, in advance, an image quality level to be supported before the call is in progress and to control the image quality and bandwidth within a predetermined range.

However, the user may need to raise an image definition level at a certain time during the call. Alternatively, the user may desire to view fast motion irrespective of the image definition level. To meet this desire, a need exists for a method capable of dynamically controlling the image quality during the call.

### SUMMARY OF THE INVENTION

Therefore, the present invention has been made in view of the above and other problems, and it is an object of the present invention to provide an IP (Internet Protocol) video terminal with a function for controlling video transmission/reception bandwidth and image quality and a control method thereof that can allow a user to directly manipulate a menu and control the video transmission/reception bandwidth and image quality so that the user can be adaptive to a dynamic change of Internet conditions during a call.

In accordance with a first aspect of the present invention, the above and other objects can be accomplished by the provision of an IP (Internet Protocol) video terminal with a function for controlling video transmission/reception bandwidth and image quality, comprising: a control module for supporting a user's manipulation so that the bandwidth and image quality can be controlled; a video module comprising a camera and an LCD (Liquid Crystal Display) for receiving an input from the camera to compress the received input into digital data to be used in IP communication according to a bandwidth value and an image quality value set by the control module, or receiving data over the Internet to decompress the received data according to the set bandwidth value and the set image quality value and output the decompressed data to the LCD; an audio module comprising a microphone and a speaker for receiving an input from the microphone to compress the received input into digital data to be used in the IP communication according to the bandwidth value and the image quality value set by the control module, or receiving data over the Internet to decompress the received data and output the decompressed data to the speaker; a media processor for processing the data encoded in the video and audio modules so that the data can be transmitted over the Internet, or converting the data received over the Internet into a data format recognizable in the video and audio modules; a network module provided between the media processor and the Internet for interfacing with the internet through an Internet line; and a main processor for receiving the set bandwidth value and the set image quality value from the control module, converting the set bandwidth value and the set image quality value into QPs (Quantization parameters), and setting the QPs as encoding and decoding-related factors in the video module.

In accordance with a second aspect of the present invention, the above and other objects can be accomplished by the provision of a control method of an IP (Internet Protocol) video terminal with a function for controlling video transmission/reception bandwidth and image quality, comprising: while a call is in progress, controlling video transmission bandwidth and quality of the IP video terminal. Preferably, the control method further comprises: while the call is in progress, exchanging information with an opposite party and controlling a transmission rate and quality of video from the opposite party. Preferably, the control method further comprises: while the call is in progress, recognizing a network state and automatically controlling video transmission quality according to a change of the network state.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows the configuration of an overall network to which the present invention is applied;

FIG. 2 is a block diagram illustrating a control circuit provided in an IP (Internet Protocol) video terminal in accordance with one embodiment of the present invention;

FIG. 3 shows a screen for controlling video transmission/reception image quality and bandwidth in accordance with one embodiment of the present invention;

FIG. 4A is a flowchart illustrating a process for setting bandwidth of video data to be transmitted from the IP video terminal in accordance with one embodiment of the present invention;

FIG. 4B is a flowchart illustrating a process for setting bandwidth of video data to be received by the IP video terminal and requesting that an opposite party transmit video data on the basis of the set bandwidth in accordance with one embodiment of the present invention;

FIG. 5A is a flowchart illustrating a process for setting image quality necessary for encoding video data to be transmitted from the IP video terminal in accordance with one embodiment of the present invention; and

FIG. 5B is a flowchart illustrating a process for selecting image quality necessary for encoding video data to be received by the IP video terminal and requesting that the opposite party encode video data on the basis of the selected image quality in accordance with one embodiment of the present invention.

### DESCRIPTION OF THE PREFERRED EMBODIMENTS

Now, preferred embodiments of the present invention will be described in detail with reference to the annexed drawings.

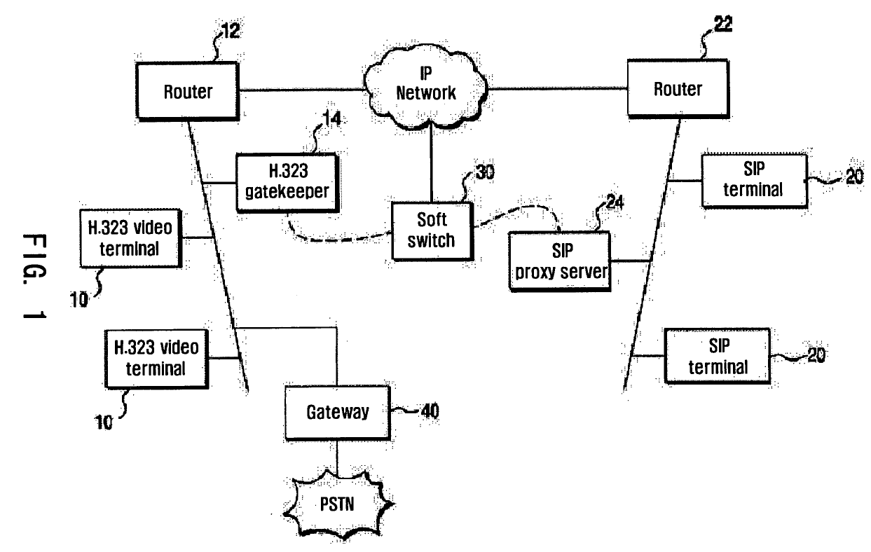

FIG. 1 shows the configuration of an overall network to which the present invention is applied. Service proposed in the present invention focuses on an MoIP (Multimedia over IP (Internet protocol)) video terminal conforming to an international protocol standard such as H.323 or SIP (Session Initiation Protocol) or a proprietary protocol. The configuration of the overall network will now be described.

As shown in FIG. 1, the network configuration using the H.323 protocol comprises an H.323 video terminal 10 for performing voice and video communication; a router 12 connected to the H.323 video terminal 10 for analyzing protocol information contained in data, selecting an optimum path and outputting the data; and an H.323 gatekeeper 14 for retrieving an IP address corresponding to an opposite phone number inputted from the H.323 video terminal 10 receiving a phone call.

The network configuration using SIP protocol comprises an SIP terminal 20; a router 22 connected to the SIP terminal 20; and an SIP proxy server 24 for retrieving a location of a called party and connecting the call to the called party.

Here, in order that the H.323 gatekeeper 14 and the SIP proxy server 24 can ensure QoS (Quality of Service) for voice/video communication through the router 12 or 22, a gateway, or a call controller by integrating various networks and applications, they are linked to a soft switch 30 for performing various functions such as an open standard API (Application Programming Interface), management between terminations and standard protocol support for signaling. The soft switch 30 is connected to an IP network linked to the router.

Moreover, the network configuration using H.323 protocol can further comprise a gateway 40 capable of exchanging information between communication networks by interconnecting other types of networks, for example, communication networks including a LAN (Local Area Network), PDN (Public Data Network), PSTN (Public Switched Telephone Network), etc.

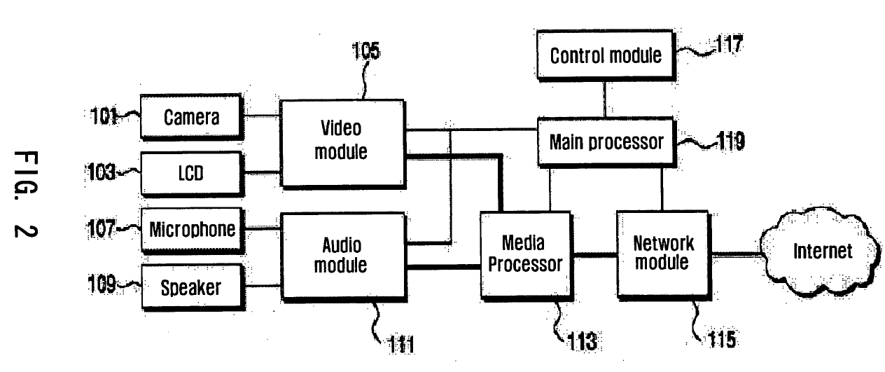

FIG. 2 is a block diagram illustrating a control circuit provided in an IP (Internet Protocol) video terminal in accordance with one embodiment of the present invention. As shown in FIG. 2, the IP video terminal comprises a video module 105 connected to a camera 101 and an LCD (Liquid Crystal Display) 103; an audio module 111 connected to a microphone 107 and a speaker 109; a media processor 113 connected to the video module 105 and the audio module 111; a network module 115 provided between the media processor 113 and the Internet; a control module 117 for supporting a user's manipulation; and a main processor 119 connected to the video module 105, the audio module 111, the media processor 113, the network module 115 and the control module 117 for generating control signals.

The video module 105 performs a function for receiving an input from the camera 101 to compress the received input into digital data to be used for IP communication, or decompressing data received over the Internet to enable the LCD 103 to display the decompressed data. The main processor 119 can set an encoding-related factor, such that an encoding operation is performed based on a set factor value.

The audio module 111 performs a function for receiving an input from the microphone 107 to compress the received input into digital data to be used for IP communication, or decompressing data received over the Internet to reproduce the decompressed data and output the reproduced data through the speaker 109. The main processor 119 can set encoding and decoding-related factors, such that encoding and decoding operations are performed based on set factor values.

The media processor 113 performs a function for processing data encoded in the video module 105 and the audio module 111 so that the data can be transmitted over the Internet, or converting data received from the Internet into a data format recognizable in the video module 105 and the audio module 111.

The network module 115 interfaces with the Internet through an Internet line.

The control module 117 includes buttons provided on the IP video terminal so that the user's manipulations, i.e., bandwidth control, image quality control, etc., can be performed.

The main processor 119 serving as a processor for operating a system performs a function for receiving a user input or network input to carry out a corresponding operation based thereon, and a function for controlling modules provided in the system.

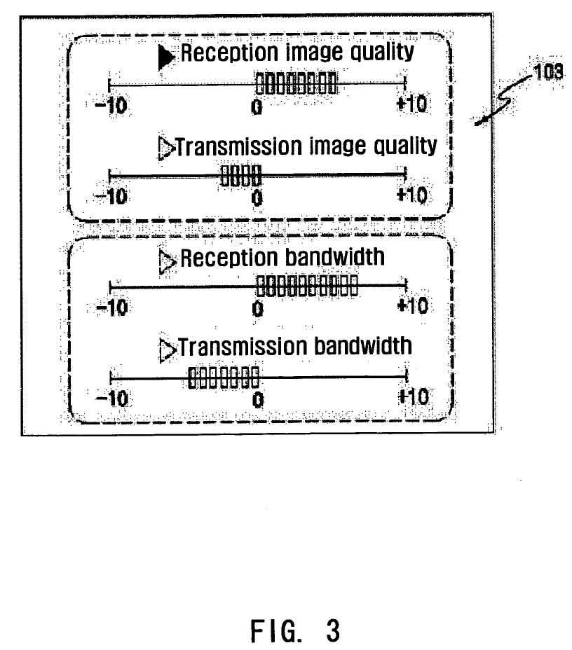

FIG. 3 shows a screen for controlling video transmission/reception image quality and bandwidth in accordance with one embodiment of the present invention. FIG. 3 shows the LCD 103 of the IP video terminal supporting the MoIP service. A menu is displayed on the LCD 103 during a call so that the LCD 103 can receive a user input. A lower portion of the LCD 103 displays a video transmission/reception bandwidth control menu during the call so that the user can change a bandwidth value using a specific button of the control module 117. An upper portion of the LCD 103 displays a video transmission/reception image quality control menu during the call so that the user can change an image quality value using a specific button of the control module 117.

As described above, the IP video terminal provides the video transmission/reception bandwidth control menu during the call. At this time, a video encoding module of the IP video terminal provides a function capable of dynamically controlling the bandwidth and image quality during encoding.

A process for controlling the IP video terminal in accordance with the present invention will be described.

When a request for bandwidth and image quality values to be used for video transmission is sent to an opposite party, a corresponding message supported in each protocol is used for video call setup. For example, a miscellaneous command and indication message serving as the corresponding message is defined in case of H.323 protocol. In case of SIP, the corresponding message is defined in an UPDATE method. Moreover, a transmission/reception process in video terminals A and B will be described with reference to the annexed drawings in accordance with this embodiment. Here, the video terminals A and B indicate subjects for performing the transmission/reception process.

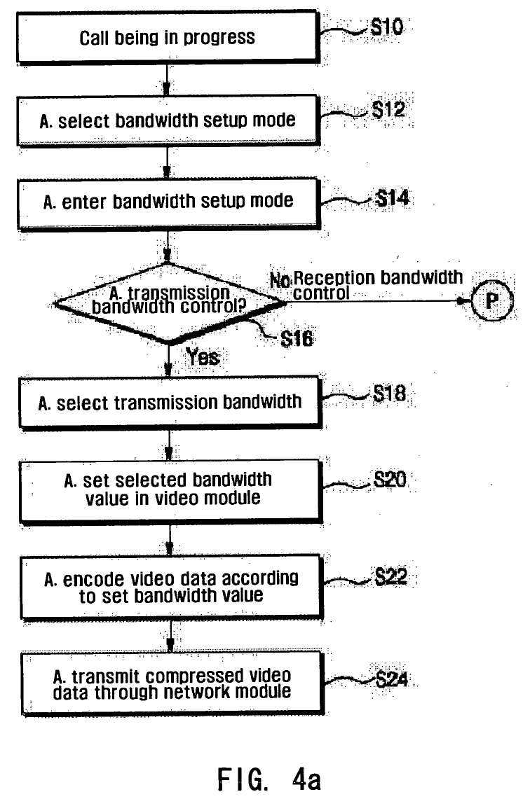

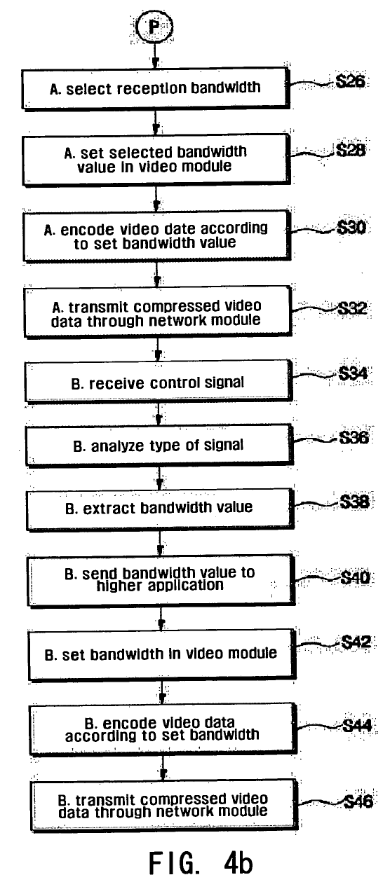

FIG. 4A is a flowchart illustrating a process for setting bandwidth of video data to be transmitted from the IP video terminal in accordance with one embodiment of the present invention. As shown in FIG. 4A, when a user of the video terminal A presses a menu button of the control module 117 during a call (S10), the main processor 119 displays a video control menu on a screen. The video control menu includes bandwidth control items and image quality control items. When desiring to set the bandwidth, the user of the video terminal A selects a bandwidth setup mode by pressing a specific button of the control module 117 or clicking the screen in case of a touch screen (S12). Thus, the video terminal A enters the bandwidth setup mode (S14). Then, the user of the video terminal A selects one of the transmission and reception bandwidth control items (S16). At this point, when the user of the video terminal A has selected the transmission bandwidth control item, he or she selects an appropriate transmission bandwidth value using a specific button of the control module 117 (S18). Thus, the main processor 119 of the video terminal A sets a new bandwidth value in the video module 105 (S20). The video module 105 of the video terminal A encodes video data according to the set bandwidth and then sends the encoded video data to the media processor 113 (S22). At last, the media processor 113 of the video terminal A transmits media data through the network module 115 (S24).

FIG. 4B is a flowchart illustrating a process for setting bandwidth of video data to be received by the IP video terminal and requesting that an opposite party transmit video data on the basis of the set bandwidth in accordance with one embodiment of the present invention. As shown in FIG. 4B, when the user of the video terminal A has selected the reception bandwidth control item of the transmission and reception bandwidth control items, he or she selects an appropriate reception bandwidth value using a specific button of the control module 117 (S26). Thus, the main processor 119 of the video terminal A creates a message appropriate for the protocol used in current video communication with a newly set bandwidth value and then transmits the created message to the opposite party through the network module 115 (S28˜S32).

On the other hand, when receiving a bandwidth setup message (S34), the network module 115 of the video terminal B sends the received bandwidth setup message to the main processor 119 so that the signal type can be analyzed (S36). The main processor 119 extracts a bandwidth value (S38) and sets a requested bandwidth value in the video module 105 (S40˜S42). The video module 105 of the video terminal B encodes video data according to the set bandwidth and sends the encoded video data to the media processor 113 (S44). Subsequently, the media processor 113 of the video terminal B transmits media data through the network module 115 (S46).

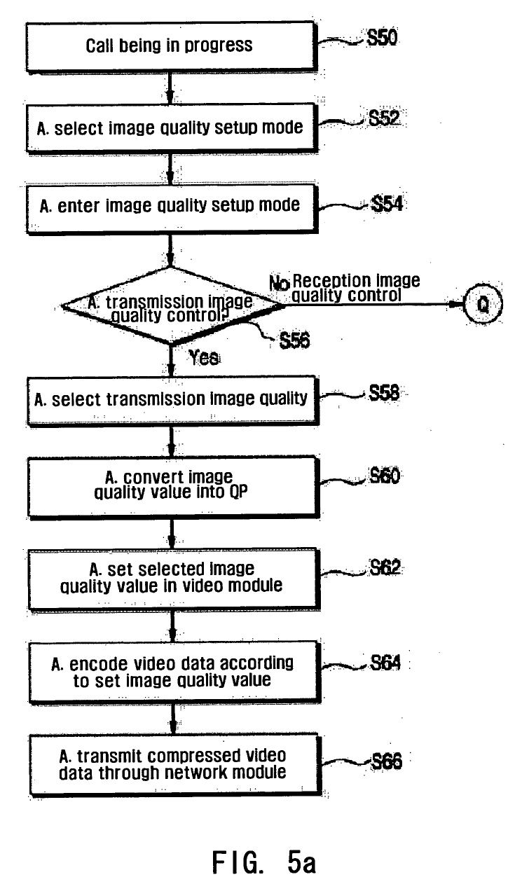

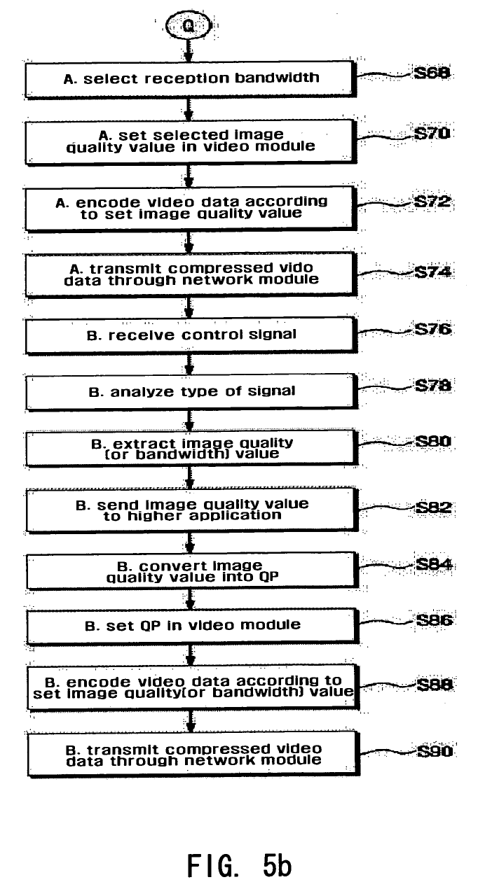

FIG. 5A is a flowchart illustrating a process for setting image quality necessary for encoding video data to be transmitted from the IP video terminal in accordance with one embodiment of the present invention. As shown in FIG. 5A, when the user of the video terminal A presses a menu button of the control module 117 during the call (S50), the main processor 119 displays a video control menu on a screen. The video control menu includes bandwidth control items and image quality control items. When desiring to set the image quality, the user of the video terminal A selects an image quality setup mode by pressing a specific button of the control module 117 or clicking the screen in case of a touch screen (S52). Thus, the video terminal A enters the image quality setup mode (S54). Then, the user of the video terminal A selects one of the transmission and reception image quality control items (S56). At this point, when the user of the video terminal A has selected the transmission image quality control item, he or she selects an appropriate transmission image quality value using a specific button of the control module 117 (S58). Thus, the main processor 119 of the video terminal A converts a newly set image quality value into a QP (Quantization Parameter) (S60) and sets the QP in the video module 105 (S62). The video module 105 of the video terminal A encodes video data according to the set QP and then sends the encoded video data to the media processor 113 (S64). At last, the media processor 113 of the video terminal A transmits media data through the network module 115 (S66).

FIG. 5B is a flowchart illustrating a process for selecting image quality necessary for encoding video data to be received by the IP video terminal and requesting that an opposite party encode video data on the basis of the selected image quality in accordance with one embodiment of the present invention. As shown in FIG. 5B, when the user of the video terminal A has selected the reception image quality control item of the transmission/reception image quality control items, he or she selects an appropriate reception image quality value using a specific button of the control module 117 (S68). Thus, the main processor 119 of the video terminal A creates a message appropriate for the protocol used in current video communication with a newly set image quality value and then transmits the created message to the opposite party through the network module 115 (S70˜S74).

On the other hand, when receiving an image quality setup message (S76), the network module 115 of the video terminal B sends the received image quality setup message to the main processor 119. The main processor 119 extracts an image quality (or bandwidth) value (S80) and converts the extracted image quality value into a QP to set the QP in the video module 105 (S82˜S86). The video module 105 of the video terminal B encodes video data on the basis of a set image quality (or bandwidth) value and sends the encoded video data to the media processor 113 (S88). At last, the media processor 113 of the video terminal B sends media data through the network module 115 (S90).

In order that communication quality can be controlled according to a user request or an Internet state dynamically varying while a call is in progress in the IP video communication of the present invention, the present invention allows the user to select appropriate video transmission/reception bandwidth and image quality through a menu displayed on the LCD 103, as described above.

In accordance with the present invention, video transmission bandwidth and image quality information set by the user during the call is sent to the video compression module, such that video transmission data can be controlled. Video reception bandwidth and image quality information is sent to an opposite video terminal through a signal defined in a standard, such that video data based on a value of the information can be received. When communication quality is lowered due to a degraded bandwidth state or the definition of image quality must be increased, during the call, the user can directly control video quality if desiring to naturally view motion of the opposite party at a faster speed during the call.

Moreover, when the IP video terminal has a function capable of predicting a network connection state with an opposite party during the call, it can add, to a system, a function capable of automatically controlling video transmission/reception bandwidth and image quality in response to the predicted network connection state. That is, the IP video terminal selects optimum video transmission bandwidth and image quality while taking into account a current network state and sets the selected transmission bandwidth and image quality in a media process module. Moreover, the IP video terminal selects optimum video reception bandwidth and image quality and sends information of the selected reception bandwidth and image quality to the opposite party through the signal in the above-described algorithm. Thus, service is provided so that the opposite party can control transmission video quality.

For example, the present invention can be applied to video data transmission/reception services including video telephone, video conference, video chatting, VOD (Video On Demand) service, etc., such that it allows the user to control video transmission bandwidth and quality through a terminal during the call, and to exchange information with the opposite party during the call and control a video transmission rate and quality of the opposite party.

As apparent from the above description, the present invention provides an IP (Internet Protocol) video terminal with a function for controlling video transmission/reception bandwidth and video quality and a control method thereof that can acquire more natural video by lowering a bandwidth value or/and an image quality value when quality of video from an opposite party is bad while a call is in progress.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The entire content of Priority Document No. 10-2003-76290 is incorporated herein by reference.

1. An IP (Internet Protocol) video terminal with a function for controlling video transmission/reception bandwidth and image quality, comprising:
a control module for supporting a user's manipulation so that the bandwidth and image quality can be controlled;
a video module comprising a camera and an LCD (Liquid Crystal Display) for receiving an input from the camera to compress the received input into digital data to be used in IP communication according to a bandwidth value and an image quality value set by the control module, or receiving data over the Internet to decompress the received data according to the set bandwidth value and the set image quality value and output the decompressed data to the LCD;
an audio module comprising a microphone and a speaker for receiving an input from the microphone to compress the received input into digital data to be used in the IP communication according to the bandwidth value and the image quality value set by the control module, or receiving data over the Internet to decompress the received data and output the decompressed data to the speaker;
a media processor for processing the data encoded in the video and audio modules so that the data can be transmitted over the Internet, or converting the data received over the Internet into a data format recognizable in the video and audio modules;
a network module provided between the media processor and the Internet for interfacing with the Internet through an Internet line; and
a main processor for receiving the set bandwidth value and the set image quality value from the control module, converting the set bandwidth value and the set image quality value into QPs (Quantization parameters), and setting the QPs as encoding and decoding-related factors in the video module.

2. A control method of an IP (Internet Protocol) video terminal with a function for controlling video transmission/reception bandwidth and image quality, comprising the step of:
(a) while a call is in progress, controlling video transmission bandwidth and quality of the IP video terminal.

3. The control method of claim 2, further comprising the step of:
(b) while the call is in progress, exchanging information with an opposite party and controlling a transmission rate and quality of video from the opposite party.

4. The control method of claim 2, further comprising the step of:
(c) while the call is in progress, recognizing a network state and automatically controlling video transmission quality according to a change of the network state.

5. The control method of claim 2, further comprising the step of:
(d) setting bandwidth of video data to be transmitted from a video terminal (A), the step (d) comprising the steps of:
entering a bandwidth setup mode of the video terminal (A) and outputting a transmission bandwidth control menu;
setting a transmission bandwidth value of the video terminal (A);
encoding the video data according to the set bandwidth value; and
transmitting the encoded video data over a network.

6. The control method of claim 2, further comprising the step of:
(e) setting bandwidth of video data to be received by a video terminal (A) and requesting that a video terminal (B) transmit video data according to the set bandwidth, the step (e) comprising the steps of:
entering a bandwidth setup mode of the video terminal (A) and outputting a reception bandwidth control menu;
setting a reception bandwidth value of the video terminal (A);
encoding the video data according to the set bandwidth value;
transmitting the encoded video data over a network;
by the video terminal (B), receiving a bandwidth setup message and extracting the bandwidth value from the received message;
encoding the video data according to the extracted bandwidth value; and
by the video terminal (B), transmitting the encoded video data over the network.

7. The control method of claim 2, further comprising the step of:
(f) setting image quality for encoding video data to be transmitted from a video terminal (A), the step (f) comprising the steps of:
entering an image quality setup mode of the video terminal (A) and outputting a transmission image quality control menu;
setting a transmission image quality value of the video terminal (A);
converting the set image quality value into a QP (Quantization Parameter);
encoding the video data according to the QP; and
transmitting the encoded video data over a network.

8. The control method of claim 2, further comprising the step of:
(g) selecting image quality for encoding video data to be received by a video terminal (A) and requesting that a video terminal (B) encode video data according to the selected image quality, the step (g) comprising the steps of:
entering an image quality setup mode of the video terminal (A) and outputting a reception image quality menu;
setting a reception image quality value of the video terminal (A);
encoding video data according to the set image quality value or a set bandwidth value;
transmitting the encoded video data over a network;
by the video terminal (B), receiving an image quality setup message and extracting the bandwidth value;
extracting the image quality value and converting the extracted image quality value into a QP (Quantization Parameter);
encoding the video data according to the QP; and
by the video terminal (B), transmitting the encoded video data over the network.

9. The control method of claim 3, further comprising the step of:
(c) while the call is in progress, recognizing a network state and automatically controlling video transmission quality according to a change of the network state.

10. The control method of claim 3, further comprising the step of:
(d) setting bandwidth of video data to be transmitted from a video terminal (A), the step (d) comprising the steps of:
entering a bandwidth setup mode of the video terminal (A) and outputting a transmission bandwidth control menu;
setting a transmission bandwidth value of the video terminal (A);
encoding the video data according to the set bandwidth value; and
transmitting the encoded video data over a network.

11. The control method of claim 3, further comprising the step of:
(e) setting bandwidth of video data to be received by a video terminal (A) and requesting that a video terminal (B) transmit video data according to the set bandwidth, the step (e) comprising the steps of:
entering a bandwidth setup mode of the video terminal (A) and outputting a reception bandwidth control menu;
setting a reception bandwidth value of the video terminal (A);
encoding the video data according to the set bandwidth value;
transmitting the encoded video data over a network;
by the video terminal (B), receiving a bandwidth setup message and extracting the bandwidth value from the received message;
encoding the video data according to the extracted bandwidth value; and
by the video terminal (B), transmitting the encoded video data over the network.

12. The control method of claim 3, further comprising the step of:
(f) setting image quality for encoding video data to be transmitted from a video terminal (A), the step (f) comprising the steps of:
entering an image quality setup mode of the video terminal (A) and outputting a transmission image quality control menu;
setting a transmission image quality value of the video terminal (A);
converting the set image quality value into a QP (Quantization Parameter);
encoding the video data according to the QP; and
transmitting the encoded video data over a network.

13. The control method of claim 3, further comprising the step of:
(g) selecting image quality for encoding video data to be received by a video terminal (A) and requesting that a video terminal (B) encode video data according to the selected image quality, the step (g) comprising the steps of:
entering an image quality setup mode of the video terminal (A) and outputting a reception image quality menu;
setting a reception image quality value of the video terminal (A);
encoding video data according to the set image quality value or a set bandwidth value;
transmitting the encoded video data over a network;
by the video terminal (B), receiving an image quality setup message and extracting the bandwidth value;
extracting the image quality value and converting the extracted image quality value into a QP (Quantization Parameter);
encoding the video data according to the QP; and
by the video terminal (B), transmitting the encoded video data over the network.
